(19) United States
(12) Patent Application Publication
(10) Pub. No.: US 2010/0146609 A1
(43) Pub. Date: Jun. 10, 2010

(54) METHOD AND SYSTEM OF SECURING ACCOUNTS

(76) Inventor: Rob Bartlett, Westbank (CA)

Correspondence Address: FASKEN MARTINEAU DUMOULIN LLP, 2900 - 550 Burrard Street, VANCOUVER, BC, V6C 0A3, CA

(21) Appl. No.: 12/444,133

(22) PCT Filed: Oct. 4, 2007
(86) PCT No.: PCT/CA07/01767

§ 371 Date: Apr. 2, 2009

Related U.S. Application Data
(60) Provisional application No. 60/849,008, filed on Oct. 4, 2006.

(51) Int. Cl. H04L 9/32

(52) U.S. Cl. 726/7

(57) ABSTRACT

A method and system of securing account is provided. When a client computer requests access to an account accessible via a server, the server determinates a mac address associated with the client computer and compares it to a mac address associated with the account. If the mac address of the client computer is not the same as the mac address associated with the account, the server initially denies access to the client computer, but may allow access after verification of the client computer by the user associated with the account.

This application claims the benefit of U.S. Provisional Patent Application No. 60/849,008, filed Oct. 4, 2006, which is hereby incorporated by reference.

### FIELD OF THE INVENTION

This invention relates to methods and systems of conducting secure transactions over a computer network, and more particularly to securing authentication systems used in such transactions.

### BACKGROUND OF THE INVENTION

Networks, particularly the global computer network known as the Internet, are now used for many purchases and other business transactions, usually by means such as a credit card. A key component of these credit card transactions is the ability to authenticate the holder of the credit card, as the absence of signatures and face-to-face contact between the transacting parties makes authentication of the credit card holder difficult.

At present, malicious users can gain unauthorized access to online accounts and/or credit cards of account users by hacking, or stealing or phishing passwords or personal info. These accounts may include game accounts, bank accounts, and online payment processing systems like those offered by PayPal™ or credit card processors. Currently, the preferred way to offer significant security online is to request additional security questions from the user, which is an inconvenience to the user, and possibly a further security risk. Most online authentication systems therefore trade convenience for security.

Online banking tends to have significantly better security compared to payment systems for other account providers such as PayPal, or accounts for online games. This is because if a malicious user gains access to an online bank account, they can do a significant amount of damage, and the bank may be liable (they have no merchants on whom to offload the liability). Therefore, it is in the bank's best interest to ensure that it is difficult to access an online bank account. Some banks use cookies and additional security questions to secure their systems, but, as described above, this is an inconvenience to clients.

Most account providers, such as game companies and payment processors, have relatively weak authentication systems. Once a password is known, a malicious user may access accounts and misuse such accounts, usually from any computer. The account provider and/or the account user must take steps to protect their account. As an example, PayPal requests an account user to verify their account and address at registration, but once that is completed, only a single password is needed to allow access to the account.

Credit card processors typically ask account users for address verification and the Credit Card Verification (CCV) number on the back of the card; and may also ask account users for a password. If a malicious user accesses this information, they may make fraudulent orders with the credit card. Therefore, it is up to the merchant accepting the credit card to protect themselves against malicious users as the credit card payment processor will not usually take the necessary steps to do so (for example by comparing the Internet Protocol (IP) address of the client computer operated by the credit card user to the region in which the order is being made, or calling the credit card user).

Internet service providers (ISPs) may restrict access of users to the Internet, often based on the Media Access Control (MAC) address of the computer being used. If a user tries to connect a new computer to the ISP using an Internet connection, they may have to register the new MAC address with the ISP before receiving permission. The MAC address of a computer is a unique identifier that can correctly identify a particular computer on a local area network. It is possible to spoof or change a MAC address, but typically it is only possible to discover the MAC address of a computer from the same local area network.

Some account providers, such as online banks, use improved security systems which are cookie based. These systems ask an account user to “remember this computer” or “remember this password” after asking one or two security questions. Once the computer is registered, these extra questions are not asked again unless the cookies are deleted from the computer. A deficiency of this system is that it requires the use of cookies, which is not permitted by all account users and many account users do not want to provide answers to additional security questions to access their account.

There have been various attempts in the prior art to solve this account user authentication issue, including U.S. Patent Publication No. 2004/0117321 to Sancho, for a system and method for secure network purchasing. Sancho discloses that once a merchant/client transaction is initiated, that it can be traced back to the originating computer using the IP address of that computer, which does not change during the transaction.

U.S. Patent Publication No. 2005/0177442 to Sullivan et al., for a method and system for performing a retail transaction using a wireless device, discloses a method of identifying a wireless Internet connection for an online purchase, and matching a customer account with transaction data. This system is dependent on a customer account registered with the wireless device, and requires the computer to already have a registered customer account.

U.S. Patent Publication No. 2005/0033653 to Eisenberg et al., for an electronic mail card purchase verification, discloses a method of looking for additional information about the purchaser to verify that the transaction is not suspicious. This application discloses an automation process for standard security checks known in the art.

U.S. Patent Publication No. 2004/0243832 to Wilf et al., for a verification of a personal identifier received online, discloses a method of ensuring secure communication between two computers over a connection.

PCT Patent Application No. WO 2004/027620 to Freidman et al., for an authentication system and method, discloses an authentication system with proprietary identification codes, which must be installed on the client/authenticating computers. The MAC address of the computer is used along with other system details to produce a unique identifier for the client computer that is software dependent. A system that requires such a software installation may be difficult to implement (and account users may not want to install additional software). Such systems also limit the account user to a single computer, and must be reinstalled when making a purchase or accessing an account from a new computer. If any system is too complicated, while it may be secure, it may not practical in application. This is a reason why most current authentication systems (with the exception of bank accounts and very secure sites) are poor, as they trade convenience for security.

PCT Patent Application No. WO 2006/083063 to Park, for a system and method for mediating and conducting peer-to-peer electronic commerce, discloses a method of allowing people who don't have a commercial website to have their product details spidered and sold on a regular website.

U.S. Patent Publication No. 2006/0068785 to Kamijo et al., for a secure communication over a medium, discloses a process to assist in securing insecure communications using a cell phone.

U.S. Patent Publication No. 2005/0209876 to Linlor, for a secure money transfer between hand-held devices, discloses a method of storing a clients billing information in a database and then making a purchase from their computer using a Personal Identification Number (PIN) or biometrics to identify themselves.

### BRIEF SUMMARY OF THE INVENTION

What is needed is a system that is pre-emptive and uses technology already available on every computer that accesses the Internet; so that additional software may not be required on the client computer operated by the account user. The system according to the invention preferably uses a database independent of the client computer, and works in conjunction with traditional authentication systems, or optionally without traditional authentication at all (such as with standard online credit card transactions).

The system according to the invention includes a method to determine the MAC address of a computer and other identifying details from outside the local area network (e.g., via the Internet) using common online scripting languages.

Authentication is not required for the system according to the invention to function; instead the system assists in securing existing authentication systems and online credit card transactions. The system is also comprehensive and complete, actually offering an automated security solution when suspicious transactions are made. In addition to specifying the computer used in any online transaction using the MAC address of the computer, the system according to the invention may also show the IP address of the connecting computers between the client computer and the receiving server. This allows administrators to determine if the alleged account user is using spoofing technology to try and hide their identity. The system according to the invention may be used for law enforcement, by discreetly capturing significant data from online criminals and terrorists.

For an additional level of security, more stringent computer identification may be implemented and biometrics may be integrated with the system according to the invention to gain access to highly sensitive online accounts for government and law enforcement.

The security system according to the invention is a companion for existing authentication and processing systems. The system may provide for:

1. a reduction in hacking, fraudulent charges, and staff needed to administer a current security system;
2. an improvement in client/merchant satisfaction, and the ability to use the effectiveness of the system as selling point;
3. revenue potential (for payment processors and publishers) for the enhanced security services;
4. creation of highly secure authentication systems for federal or law enforcement applications accessible via the Internet;
5. elimination of the threat of fraudsters or hackers using IP spoofing to hide their identities and commit fraud; and
6. Provision of a system useful for espionage and for law enforcement to collect data from online criminals or terrorists.

A system for enhancing security between a client and a server is provided, including: a database, accessible by the server, the database having a record associated with an account, the account associated with a MAC address; wherein when the client accesses the account, the server receives the MAC address associated with the client and compares the MAC address associated with the client to the MAC address associated with the account, and if the MAC address associated with the client is the same as the MAC address associated with the account, permits access to the account.

If the MAC address associated with the client is not the same as the MAC address associated with the client, the server communicates with said client to determine if access to the account should be permitted.

The account may associated with a geographic area, and the server receives an IP address associated with the client, and if the geographic area associated with the IP address is not the same as the geographic area associated with the account or the MAC address of the client is not the same as the MAC address associated with the account, the server denies access to the account. If the geographic area associated with the IP address is not the same as the geographic area associated with the account and the MAC address of the client is not the same as the MAC address associated with the account, the server may notify law enforcement of the IP address and MAC address of the client.

The account may be associated with biometric information related to a user, and the server receives the biometric information from the client.

### DESCRIPTION OF THE FIGURES

Exemplary embodiments are illustrated in referenced figures of the drawings. It is intended that the embodiments and figures disclosed herein are to be considered illustrative rather than restrictive.

FIG. 1 is a block diagram of a system according to the invention;

FIG. 2 is a flow chart showing the process by which an account is opened according to the invention;

FIG. 3 is a flow chart showing the process by which an account is accessed according to the invention;

FIG. 4 is a block diagram showing the interaction between an ActiveX Control Container and a Windowed ActiveX Control;

FIG. 5 is a block diagram showing communication between an ActiveX Control Container and an ActiveX Control; and

FIG. 6 is a block diagram showing a Java security architecture.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded as being illustrative and not restrictive.

The system, according to the invention, restricts access to an account (or a credit card) based on the MAC address of the network card 30 in client computer 20 used by the account user 10. Each network card 30 is identifiable by a unique MAC address.

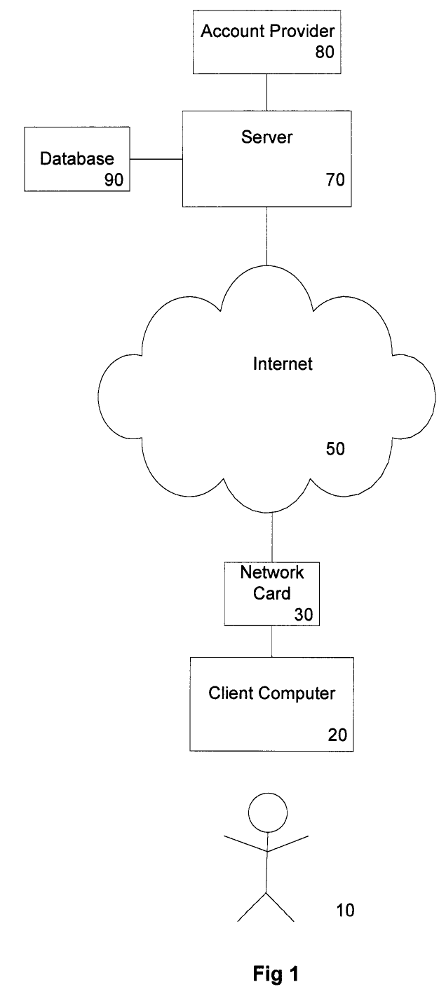

A typical system incorporating the invention is shown in FIG. 1. Account user 10, accesses the Internet 50 via client computer 20 to communicate with a server 70 operated by account provider 80. Server 70 may be a single computer, software running on a computer, or a plurality of computers. Server 70 communicates with database 90 which may be within server 70 or one or more computers in communication with server 70. Account provider 80 also has access to database 90. Client computer 20 includes a network card 30 for communications, network card 30 having a MAC address.

To use the secure account, the MAC address of the client computer must be registered with the server permitting access to the account. If client computer 20 tries to access an account or use a credit card via an unregistered computer (and therefore unregistered MAC address), then the registered account user 10 may be notified by e-mail and/or by phone, and the account, transaction or credit card can be suspended due to the suspicious action until the account user 10 verifies the transaction. If account user 10 was just using a different, unregistered computer, account user 10 can respond to the notification and the account can be re-activated without intervention from a “live” person.

The MAC address of a particular computer is positioned one level below an IP address, and within a local network it can be determined by sending an “arp-a” request. MAC addresses of computers accessing the Internet are determined and used by ISPs routinely to restrict or allow access to the Internet by sending a Dynamic Host Configuration Protocol (DHCP) request or an Address Resolution Protocol (ARP) request to the client computer. These requests involve sending a message to the client computer 20 with the request, which in turn responds with the MAC address.

Communications sent through the Internet only retain the MAC address of the last IP/Hop in the transmitted packet, meaning that the MAC address of the original client computer 20 is not usually preserved as the packet goes from router to router throughout the Internet. However, there are several ways of determining the MAC address of client computer 20, including the following:

1. Capturing the MAC address from the first router or hop receiving the packet from client computer 20. Such a method requires a series of queries of previous routers and requires cooperation from the ISPs involved.
2. “Spoofing” a DHCP packet or ARP request with the connecting computer (as sent from the local subnet) and storing the resulting MAC address in a text file to be sent back to the requesting server 70.
3. Using a script that reports the MAC address and may also report the IP address and/or host name of client computer 20 for a message received from a connecting computer. For the purposes of law enforcement, additional details could be determined for investigation of criminals or terrorists. A secure script, digitally signed by a well-known and secure source, will allow users to run the script without security warnings. Such a script can be created using commonly used Internet scripting languages, or the script can be included as an application add-on or plug-in for computer programs or websites that use authentication; or the script may be a small stand alone application distributed by credit card issuers or payment processors.

In a preferred embodiment of the invention, more than one of these means for obtaining a MAC address may be used.

Microsoft™ or Java™ software may be used to implement the system in order to provide scripts with compatibility with most systems. The system is designed for maximum compatibility and discreet operation. In a preferred embodiment, code implementing the method according to the invention is downloaded from a web server and then executed on client computer 20 and account provider server

### Embodiment Using ActiveX™ Controls

The system and method according to the invention may be implemented using ActiveX controls, which are software components based on the Component Object Model (COM™) environment provided by Microsoft™. Like Java applets, ActiveX controls 100 can be used to add rich content to web pages. Unlike applets, ActiveX controls 100 are limited to use in Microsoft's Internet Explorer™ web browser.

In the context of this document, the term “ActiveX” is used to refer to the technology that downloads and runs controls in one of the formats supported by the “Authenticode” code signing system, and corresponds to controls that can be declared from a web page using an OBJECT tag. Such controls include: COM controls (filetypes .DLL and .OCX); Win32 executable files (filetype .EXE); INF set-up files, used to specify locations and versions for a collection of other files (filetype .INF); and “cabinet” files that are referred to by an OBJECT tag (filetype .CAB). These controls are all treated in a very similar way by web-enabled ActiveX container 120 applications, including in the use of the same caching and versioning mechanisms.

ActiveX controls 100 are highly portable COM objects, and are used extensively throughout Microsoft Windows platforms and, especially, in web-based applications. COM objects, including ActiveX controls 100, can invoke each other locally and remotely through interfaces defined by the COM architecture. The COM architecture allows for interoperability among binary software components produced in disparate ways.

If an ActiveX control 100 is not installed locally, it is possible to specify a URL where the control can be obtained by account user 10. Once obtained, the control 100 installs itself on client computer 20 automatically if permitted by the browser. Once it is installed, it can be invoked without the need to be downloaded again.

ActiveX controls 100 can be signed or unsigned. A signed control provides a high degree of verification that the control was produced by the signer and has not been modified. As ActiveX controls 100 do not run in a limited environment or “sandbox”, it is important to have a high degree of trust in the author of the control.

The system and method according to the invention may be implemented using an ActiveX control 100, herein referred to as an “secureIDx control”. The secureIDx control uses several programmatic elements to interact efficiently with a control container and with account user 10. These programming elements may be: class ColeControl 130; a set of event-firing functions; and a dispatch map.

The secureIDx control object inherits a set of features from its MFC base class, ColeControl 130. These features include in-place activation and Automation logic. COleControl can provide the control object with the same functionality as an MFC window object and the ability to fire events. COleControl can also provide windowless controls, which rely on their container 120 for some of the functionality a window otherwise provides, but offers faster display than windows. The fired events are used to notify the control container when something important happens in the control. The automatic logic in the secureIDx control interacts with client computer 20 and creates a unique signature for client computer 20. This unique identity of client computer 20 works as an authentication token in addition to the existing authentication systems, or as an identity token itself. SecureIDx is derived from client computer 20's MAC Address and may also be derived from the client computer's IP Address or the account user's biometrics.

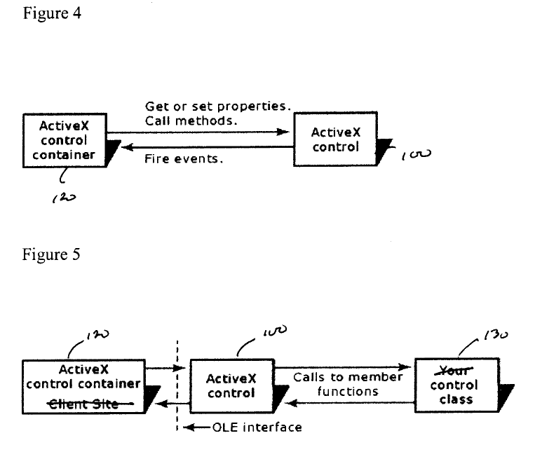

When a control 100 is used within a control container 120, it uses two mechanisms to communicate: it exposes properties and methods, and it fires events. FIGS. 4 and 5 demonstrate how these two mechanisms are implemented.

ActiveX controls 100 are an integral part of systems and applications, and they are required for essential functions in many environments. Though priorities many change from organization to organization and user to user, it is important to understand the tradeoffs between functionality and security and to make informed decisions about the appropriate level of risk.

### Authenticode and Software Signing

Software downloaded from the Internet to client computers 20 may contain unauthorized programs or viruses intended to cause damage or provide clandestine network access for malicious users. As networks become more interconnected, the threat of malicious software and viruses has extended. To counter this growing threat, Microsoft developed Authenticode™ technology to enable developers to digitally sign software using standard X.509 public key certificates. Account users can verify the publisher of digitally signed software as well as verify that the software has not been tampered with, because the publisher has signed the code. For software distributed on the Internet, most users are more likely to trust software signed by certificates issued by a reputable commercial certification authority. Therefore, if software is distributed via the Internet, it is useful to obtain the services of a commercial certification authority to issue digital signing certificates to sign the application.

### Java Embodiment

The system and method according to the invention can also be implemented using Java. Java refers to a programming language; a virtual machine designed to run that language (also known as the “JVM”); and a set of APIs and libraries. The libraries are written in a combination of Java and other programming languages, for example C and C++.

The Java language is object-oriented, with all code defined as part of a class. When the software is implemented using a JVM, these classes are dynamically loaded as modules of code that can be separately compiled. Classes are stored and represented as a sequence of bytes in a standard format, called the classfile format. (They need not be stored in files as such—it is possible to create and load classfiles on the fly, for example by downloading them from a network.)

Java's security model is based on several layers of verification, including: checking the structure of each classfile to make sure that it conforms to the classfile format; checking the sequence of instructions within each method to make sure that each instruction is valid, that there are no invalid jumps between instructions, and the arguments to each instruction are of the correct type. The JVM instruction set is designed to allow this analysis to be tractable; as classes are dynamically linked, consistency checks make sure that each class is consistent with its superclasses, e.g. that final methods are not overridden, and that access permissions are preserved; security restrictions are imposed on which packages can be accessed which can be used to prevent access to implementation classes that would not normally be needed by applets, for example; and runtime checks are performed by some instructions. For example, when an object is stored in an array, the interpreter (or compiled code) checks that the object to be stored is of the correct type, and the array index is not out of bounds.

This security scheme does not depend on the trustworthiness of the compiler that produced the classifies (or on whether the code was compiled from source in the Java language or from another language). The compiler for the standard API libraries must be trustworthy, but this can be ensured because the standard libraries are provided by the JVM implementation. However, the scheme is complicated, and quite difficult to implement correctly. The presence of several layers increases the potential for error; a flaw in any layer may cause the whole system to collapse. This is offset against the increased efficiency over a fully interpreted language implementation where all checking is done at run-time (such as the current implementations of JavaScript and VBScript, or of Safe-Tcl and Safe-Perl).

An applet is a software component that runs within a larger application. Java applets run in the context of a Java-enabled web browser. The web browser is responsible for maintaining the environment or “sandbox” that manages the applet's resource access. In practice, this usually serves to prevent the applet from accessing the local filesystem on client computer. The browser downloads the applet code from a web server and either embeds the applet into an HTML page or opens a new browser window to show the applet user interface. The default security manager denies applets all access to the filesystem and all network access except to the web host that supplied the applet.

The method and system may be incorporated into an applet, referred to herein as secureBox. The secureBox applet is a signed applet that once trusted by a client computer runs harmlessly on the client computer with a strict security policy. The applet securely enumerates the user's computer identity by recording the MAC address and optionally the client computer 20's IP address and/or the account user's biometric information and posts such identity to server 70 which authenticates or generates alerts based on submitted identification.

Applets do have several disadvantages. For example, applets require a Java plug-in, which is not always available. Some organizations do not permit users to install software, so these users might not view applets by default. There are also performance issues. The applet cannot run until the Java Virtual Machine is initialized, and this delay can be significant. Applets usually execute at a speed that is comparable to, but slower than, compiled applications. Finally, Java applets are considered more difficult and expensive to develop than html based pages.

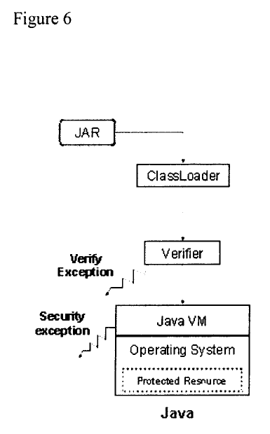

The JAR file format is a convention for using PKWARE™'s ZIP format to store Java classes and resources that may be signed. All JAR files are ZIP files, containing a standard directory called “/META-INF/”. The META-INF directory includes a “manifest file”, with name “MANIFEST.MF”, that stores additional property information about each file (this avoids having to change the format of the files themselves). It also contains “signature files”, with filetype “.SF”, that specify a subset of files to be signed by a given principal, and detached signatures for the .SF files. A typical Java security architecture is shown in FIG. 6.

### Deploying Downloadable Code

Both Java and ActiveX authenticate code by signing it using a digital signature scheme. Digital signatures use public-key cryptography; each signer has a private key, and there is a corresponding public key that can be used to verify signatures by the signing party. Assuming that the digital signature algorithm is secure and is used correctly, it prevents anyone but the owner of a private key from signing a piece of data or code.

An alternative approach to signing for authenticating controls, would be to secure the connection between the web site and the browser, using a transport protocol such as SSL 3.0 (or secure IP) that ensures the integrity of the transmitted information. The site certificate would be shown when a control runs or requests additional privileges. This would have several advantages over code signing, including: in cases where the web pages also need to be authenticated, it is much simpler than requiring two separate mechanisms, and the account user 80 sees a single, consistent certificate; it is common for controls that need extra privileges, beyond the default environment or “sandbox” permissions for Java or scripts, to also require a secure (i.e. authenticated, and optionally private) connection back to the site that served them; it simplifies creating secure systems of co-operating controls and scripts that can span pages; individual controls can be revoked at any time, by removing them from all web sites; and an malicious user cannot reuse a signed control maliciously, because the controls themselves are never signed.

It is not difficult to spoof a MAC address, however, it is extremely difficult for a malicious user, such as a hacker or fraudster, to know what the MAC address is in the first place. In order to determine the MAC address, the malicious user would have to know specifically which client computer 20 was used to access the account, which is only really possible if they have direct access to the client computer 20 being used. Further security can be provided by checking the region of the IP address and verifying the IP addresses of the connecting computers to determine if attempts have been made to hide a computer's identity.

Given the above, fraud/hacking becomes possible only by malicious users who have physical access to the client computer 20 used to access the account or credit card. If this were to happen, a report can be provided showing exactly which MAC address and IP address was used to access the account, making it easy for a particular case to be disputed by a merchant.

The system according to the invention provides both convenience and security, and fraud prevention measures/actions to prevent access/purchases from unauthorized computers. The system is practical to implement and can compliment existing online authentication checks and/or purchases.

The system may be viewed as an online computer registry and fraud/hack prevention system. The system would be queried for any publisher or merchant that wants a significant security improvement with their system.

The logic follows:

### New Account/Account Creation

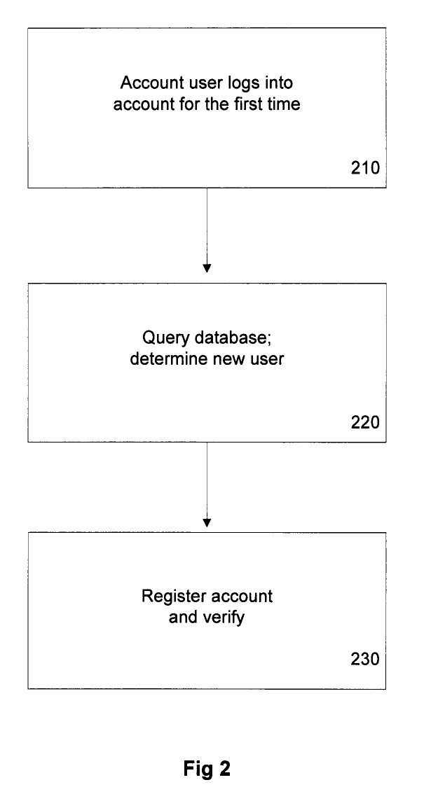

As seen in FIG. 2, an embodiment of the process by which a new account is created includes the steps:

1. In step 210, an account user 10 using a client computer 20 logs into an online account provided by an account provider 80 for the first time, or purchases a good or service online with their credit card provided by a account provider 80, such as a credit card provider for the first time.
2. In step 220, database 90 at server 70 hosting the account or used by the credit card provider to maintain the credit card account is queried, and the system determines that this is the first time the particular account or credit card has been used online.
3. In step 230, the account is registered and verified. Depending on the security level selected by the administrator of the account provider 80, client computer 20 will either:
(a) Automatically have its MAC address and IP address registered to the account or credit card and stored in database 90;
(b) Receive an e-mail automatically emailed to the e-mail address provided to the account provider, to confirm that the account user 10 has made the request. If the account user 10 confirms the request, the MAC address and IP address of client computer 20 are registered with the account or credit card. If the account user 10 does not confirm the request, the account or credit card may automatically be suspended, and an administrator notified; or
(c) Receive a phone call using the phone number provided to the account provider 80, to confirm that they have made the request. If the account user 10 confirms the request, the MAC address and IP address of the client computer 20 are registered with the account or credit card. If the account user 10 does not confirm the request, the account or credit card may be suspended, and an administrator notified. Optionally, an additional automated check could be made by an administrator using the account user's registered phone number to test the type of phone being used (PSTN line, cell phone, or VoIP). If the phone type is not appropriate (i.e. VoIP instead of a cell phone), the administrator could be notified for review and the account suspended.

### Current Account/Fraud Prevention

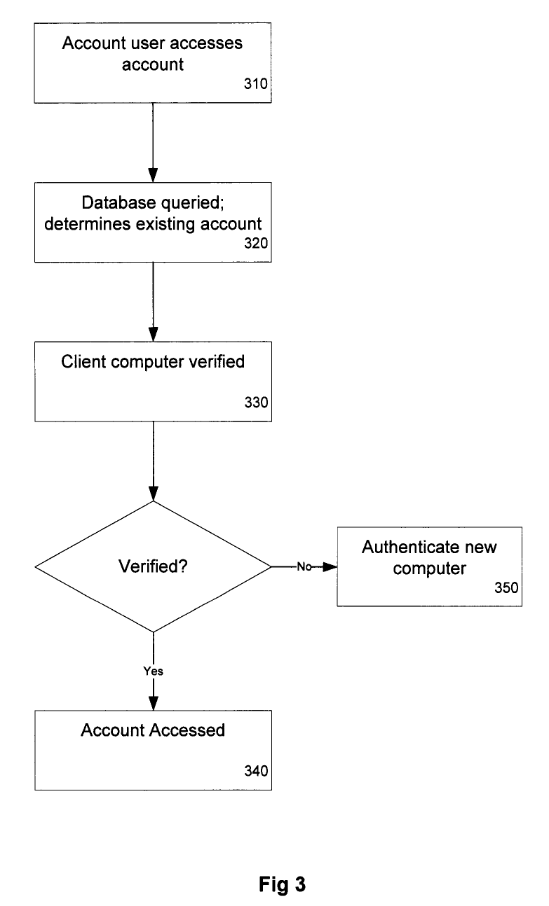

The system according to the invention can also be used to protect accounts by preventing unauthorized access to such accounts. In such a use, the following steps, as seen in FIG. 3, may occur:

1. In step 310, account user 10 logs into their existing online account, or makes a purchase with their credit card.
2. In step 320, database 90 is queried, and determines that the account accessed is an existing account.
3. In step 330, depending on the security level selected by the administrator, server 70 queries to the client computer 20 for verification purposes, specifically to determine if:
(a) The MAC address of client computer 20 matches the account;
(b) The MAC address of client computer 20 matches the account and the IP address of the client computer 20 is from the appropriate geographical region; and/or
(c) The IP address is accurate and is not being spoofed.
   4. In step 340, if the database query is successful, the authentication process or purchase continues as intended.
   5. In step 350, if the database query is NOT successful, depending on the security level selected by the administrator, the following may happen:
(a) Client computer 20 is automatically e-mailed (to the e-mail address provided to the administrator), to confirm that they have made the request. If client computer 20 confirms the request, the new MAC address and IP address are registered to the account or credit card. This automatically registers the additional computer for use with the account. If the client computer 20 does not confirm the request, the account or credit card may automatically be suspended, and an administrator notified; or
(b) The account user 10 is automatically phoned (at the phone number provided to the administrator), to confirm that they have made the request. If the account user 10 confirms the request, the new MAC address and IP address are registered to the account or credit card. This automatically registers the additional client computer 20 for use with the account. If the account user 10 does not confirm the request, the account or credit card may automatically be suspended, and an administrator notified.

For investigative purposes, the system is able to provide the true IP address and MAC address of attempted frauds or hacks, thus allowing investigators to track down fraudsters or hackers, even if they are using proxy servers. Additional information could also be used by law enforcement to help gather information regarding online criminals and terrorists.

The system is automated and has significant revenue potential by having multiple database servers (co-located or licensed) to meet demand, and charge per usage fees for database queries and automated e-mail/call services. The system according to the invention thereby may save the online industry significant amounts of time and money.

Using the system, the only fraud/hacks possible are by people who have physical access to the client computer 20. Although it is possible to spoof IP and MAC addresses, it is virtually impossible to know (or find out) which MAC address is registered with the account, unless the malicious user knows which client computer 20 was used to register the account in the first place. The true IP address functionality also eliminates the risk of IP address spoofing by showing the true IP address used by each client computer in every online transaction. The system thereby can determine which client computer was used for the transaction, which would greatly limit a merchant's liability by proving that the transaction was completed at an authorized location.

### Profiling

The system according to the invention can be used for anti-fraud/profiling purposes to allow users to look for and be notified of suspicious credit card activity. This additional protection helps make credit card transactions even more secure for online purchases.

At present credit card companies look for suspicious activity on their own. However, each credit card company sets its own criteria, which may not be suitable for every card user. The system according to the invention allows clients to determine themselves the types of purchases they want to allow with a particular credit card. For example, a card user may want to be notified if a purchase over $100 is made on their card, or if there is a purchase overseas, etc. The card users themselves know exactly how they plan on using their card, while the credit card providers do not.

If a suspicious transaction occurs, the card user can preselect to have the card immediately suspended or they can be sent an automated e-mail or phone call to confirm authorization of the purchase.

In this embodiment of the system, card users need be able to change their profile settings. For additional security, the system may require an automated confirmation e-mail or phone call to the account holder when any profile change is made.

### Revenue Model.

An operator of the system using graduated licensing and usage fees may generate revenue. For example:

1. Co-located solution—the publisher, payment processor, or other party pays the operator a monthly fee for a fixed amount of queries to a database hosted on the operator's servers. This could be done on a shared server or a dedicated server (at an additional cost). The information stored may only be for the purpose of account verification, so that personal information would not have to be stored in the database. For example, the database may just have to store the account name, or the last digits of a credit card, and the MAC address of the client computer 20.
2. Local solution—the publisher, payment processor, etc. pays a license fee to run the software and database on their own server (this may be restricted by usage, but at a lower fee than as indicated above).
3. Security notifications—a charge per usage fee for automated security notifications to the account user by e-mail (if their account or credit card is being used on an additional computer), a higher fee may be charged for automated notifications by telephone.
4. Payment processors or credit card companies may offer these enhanced services to their merchants. Game publishers, etc., may consider the system to release resources otherwise tied up dealing with hacking/security issues.

In an alternative embodiment, payment processors may access a consolidated credit card security database for each transaction, so that no password would be required. This system would offer the convenience of not having to use a password, and complete peace of mind for the cardholder and the merchant, knowing that it is not possible to place an order from a computer that has not been authorized to do so.

The invention encompasses all modifications, permutations, additions and sub-combinations of the features described herein. Although the exemplary aspects and embodiments of the invention have been disclosed in detail for illustrative purposes, it will be recognized that permutations, additions, variations, sub-combinations or modifications of the disclosed apparatus lie within the scope of the present invention.

The invention claimed is:

1. A system for enhancing security between a client and a server, comprising:
a database, accessible by the server, said database having a record associated with an account, said account associated with a MAC address;
wherein when said client accesses said account, said server receives said MAC address associated with said client and compares said MAC address associated with said client to said MAC address associated with said account, and if said MAC address associated with said client is the same as said MAC address associated with said account, permits access to said account.

2. The invention of claim 1 wherein if said MAC address associated with said client is not the same as said MAC address associated with said client, communicating with said client to determine if access to said account should be permitted.

3. The invention of claim 1 wherein said account is associated with a geographic area, and said server receives an IP address associated with said client.

4. The invention of claim 3 wherein if said geographic area associated with said IP address is not the same as said geographic area associated with said account or said MAC address of said client is not the same as said MAC address associated with said account, said server denying access to said account.

5. The invention of claim 4 wherein if said geographic area associated with said IP address is not the same as said geographic area associated with said account and said MAC address of said client is not the same as said MAC address associated with said account, said server notifies law enforcement of the IP address and MAC address of said client.

6. The invention of claim 4 wherein said account is associated with biometric information related to a user.

7. The invention of claim 6 wherein said server receives said biometric information from said client.

8. A method of allowing a client computer to access an account, comprising:
(a) said client computer requesting access to an account at a server;
(b) said server determining a MAC address associated with said client computer;
(c) said server accessing a database, said database having a MAC address associated with said account;
(d) comparing said MAC address associated with said account and said MAC address associated with said client computer;
(e) if said MAC address associated with said account and said MAC address associated with said client computer are the same, permitting access to said account.

9. The method of claim 3 further comprising the step of:
(f) if said MAC address associated with said account and said MAC address associated with said computer are different, contacting a user associated with said account.

10. The invention of claim 8 wherein a geographic area is associated with said account, and said server determining an IP address associated with said client computer.

11. The invention of claim 10 wherein if said geographic area associated with said IP address is not the same as said geographic area associated with said account, or said MAC address of said client is not the same as said MAC address associated with said account, said server denying access to said account.

12. The invention of claim 11 wherein if said geographic area associated with said IP address is not the same as said geographic area associated with said account and said MAC address of said client is not the same as said MAC address associated with said account, said server notifying law enforcement of the IP address and MAC address of said client computer.

13. The invention of claim 11 wherein said account is associated with biometric information related to a user.

14. The invention of claim 13 wherein said server receives said biometric information from said client.
